(19) United States
(12) Patent Application Publication
(10) Pub. No.: US 2008/0190031 A1
(43) Pub. Date: Aug. 14, 2008

(54) Sliding Door Construction for Platforms and Method for Assembly Thereof

(75) Inventors: Ueli Winkelmann, Kaufdorf (CH); Robert Hug, Praz (Vully) (CH); Peter Egli, Hinterkappelen (CH)

Correspondence Address: THE WEBB LAW FIRM, P.C., 700 KOPPERS BUILDING, 436 SEVENTH AVENUE, PITTSBURGH, PA, 15219, US

(73) Assignee: KABA GILGEN AG, Schwarzenburg (CH)

(21) Appl. No.: 11/995,419

(22) PCT Filed: Jul. 10, 2006
(86) PCT No.: PCT/CH2006/000362

§ 371 Date: Jan. 11, 2008

(30) Foreign Application Priority Data
Jan. 19, 2006 (EP) 06100604.5
Jul. 14, 2006 (EP) 05106496.2

(51) Int. Cl. E05D 15/06

(52) U.S. Cl. 49/427; 49/506

(57) ABSTRACT

The invention relates to a particularly reliable sliding door construction for platforms, by means of which a passenger area of platforms may be separated from a track area when closed, preventing entry to an arriving train and permitting access to the arriving train in an open state, comprising stationary regions and sliding doors, both the stationary regions and the sliding doors having a height of 1-2 m above the floor level of the passenger region above which no separation of passenger region and track region is arranged. The construction is characterized in that the sliding doors have a self-supporting embodiment and are guided to move in or on the stationary regions with provision of an upper and lower guide and one guide is embodied as a roller guide or ball bearing linear guide and one guide is embodied as a slide guide or roller guide.

### TECHNICAL FIELD

The present invention relates to the field of sliding doors for platforms, i.e. to the field of doors by means of which the passenger region of platforms is separated from the track region. Furthermore, the invention relates to a method for assembly of such a sliding door.

### PRIOR ART

For safety reasons, it is already known to fit devices between the passenger region, i.e. the actual platform, and the track region, which devices prevent the passengers from being able to enter the track region if no train has arrived and is at a standstill. This is essential in particular in the case of subway stations where the space conditions are typically extremely tight.

There are various constructions in this connection, with a differentiation being made between “platform screen doors” and “platform gate doors”.

In the case of platform screen doors, when station constructions are so to speak closed, i.e. are also upwardly closed, complete screening is ensured between the platform and the track region over the entire height. In other words, the area provided for the train is completely separated from the passenger area by a wall, and normally sliding doors are provided in the partition and open automatically only when the train is at a standstill in the correct position.

In the case of platform gate doors, rather than the entire height between said two regions being separated, only a half partition is provided which is approximately man-high and has stationary regions or fixing parts and also sliding doors arranged between them. Said construction, firstly, may be appropriate if the station is not a closed station and therefore there would not be an upper connecting edge for a platform screen door, but, secondly, it may also be necessary for different technical reasons. This is the case, for example, if it is necessary to retrofit existing platform constructions in which the pressure caused upon arrival of the train can only be compensated for via corresponding ventilation through the passenger region. In addition, it may be necessary, for fire-police reasons, for an unhindered exchange of air to be possible between the track region and the platform region, this being virtually completely ensured only in the case of a platform gate door.

The construction of platform gate doors differs in a technical respect from normal sliding doors to the effect that such doors are subjected to enormous loads because of the prevailing pressures when the train arrives, firstly on the part of the train and, secondly, on the part of the platform, because of the possible loads due to people (in particular at rush hours). In addition, the doors cannot be provided with a guide arranged above the door, and it is also desirable not to provide guide rails or guide grooves in the floor either, since such items can generally become rapidly soiled and can cause interruptions in the operation. Freely guided constructions are therefore required, which can be exposed to substantially higher loads than is the case in conventional doors known from different spheres. Added to this is that requirements which are far above those of other applications have to be imposed with regard to reliability. The doors have firstly to get through reliable opening cycles in the region of millions without any problem, they have to be able to be easily maintained, and, in particular, in the case of retrofitting, a construction has to be provided which, firstly, can be very flexibly adjusted to different circumstances (platform construction, distances between the doors of the trains, height, etc.), and which can also be fitted very rapidly, since the assembly of such constructions very frequently has to be undertaken without interrupting the transport services, i.e., for example, at night.

What stands in the way of these major technical requirements is that constructions which are as slender as possible for aesthetic and space reasons and use transparent regions are desirable.

### SUMMARY OF THE INVENTION

Accordingly, the invention is based on the object of proposing an improved sliding door construction for platforms, in particular in the form of a platform gate door. Specifically, this involves proposing a construction, by means of which, when closed, a passenger region of platforms can be separated from a track region if access to a train which has arrived is to be prevented, and which, when open, permits access to the train which has arrived, the sliding door construction comprising stationary regions and sliding doors, wherein the stationary regions and the sliding doors are at a height in the region of 1-2 m or even up to 2.5 or 3 m above the floor of the passenger region and no means for separating passenger region and track region are arranged above them.

This object is achieved in that the sliding doors are of self-supporting design and are guided movably in or on the stationary regions, in that there are an upper and a lower guide for this purpose, one guide being designed as a roller guide or as a ball bearing linear guide, and one guide being designed as a sliding guide or as a roller guide.

The core of the invention is therefore to propose a double guide for a self-supporting sliding door, which ensures increased stability and, at the same time, great reliability.

According to a first preferred embodiment, the lower guide is designed as a roller guide or as a ball bearing linear guide, and the upper guide is designed as a sliding guide.

Preferably, the lower guide is essentially arranged in the lower region of the sliding door, and/or the upper guide is essentially arranged on the upper edge or halfway up the sliding door. It is thus possible to arrange transparent regions in between, such that, firstly, there is no constricting effect because of the doors, and such that the passengers on the platform can observe the arriving train or the passengers traveling in the train can observe its arrival.

A further preferred embodiment is characterized in that the drive of the sliding doors is arranged on the guide which is designed as the roller guide or as the ball bearing linear guide and is preferably arranged at the bottom, and the driving force is transmitted with the aid of a toothed belt between drive, which is arranged in the stationary region, and the sliding door. With regard to a compact construction and to reliability, the use of a toothed belt in the lower region has proven particularly advantageous. In this case, the toothed belt can be designed, for example, such that it revolves and can be connected via a driver to the sliding door or, in particular, can be preferably connected to a guide rail provided on the sliding door, or it is possible to fixedly connect the toothed belt at its ends to a guide rail provided on the sliding door.

A particularly preferred embodiment is characterized in that a drive for each sliding door is fastened on a base plate of the respective stationary region, the drive preferably being an electric motor drive, for example with a worm gear, and in that the drive drives a toothed-belt driving roller which is arranged offset downward or upward from the main direction of the toothed belt via toothed-belt deflecting rollers. In particular if the toothed belt is connected fixedly at its ends to a guide rail provided on the sliding door, the tension of the toothed belt can be controlled and adjusted via the toothed-belt driving roller and the result is that the construction is particularly reliable.

Another preferred embodiment is distinguished in that a horizontal guide element is provided on the stationary region, in particular via at least two supporting pillars fastened on a base plate, which guide element has a length of at most the width of the stationary regions such that said guide element does not protrude beyond the stationary regions. Furthermore, a guide rail is then arranged on each sliding door and engages in the guide element or engages around the latter, with rollers or balls being provided to enable it to be movably displaced in the lateral direction.

In order to ensure that the guide rails cannot collide when the doors are open, or that doors can be arranged as close as possible next to one another, it has proven advantageous to offset the guide elements and the associated guide rails of two adjacent sliding doors in their height at least to an extent such that the guide rails of open sliding doors provided at adjacently arranged door openings come to lie one above the other without any contact. The toothed belt is preferably essentially arranged below the guide rails or the guide element. The toothed-belt plane preferably runs horizontally.

According to another preferred embodiment, in order to provide, on the platform side, a construction which is as elegant as possible and which is also protected against access, the two guides are arranged on that side of the sliding door and of the stationary regions which faces away from the platform.

In order to meet the great displaceability of the sliding doors in a structurally simple manner and not to make laterally protruding elements necessary, it has proven advantageous to design the upper guide which is designed as a sliding guide as a telescopic guide which is in at least three parts and has a guide profile connected fixedly to the stationary region, a guide-profile rail connected fixedly to the respective sliding door and a telescopic profile which is movable with respect to the two other elements. A telescopic profile of this type can also be configured on the basis of a rolling profile instead of a sliding profile. If a sliding guide is used, it has additionally proven advantageous, if appropriate, to provide the sliding regions with a special coating, for example made of PTFE.

Another embodiment of the upper guide is characterized in that the upper guide is essentially arranged halfway up the sliding door, with that region of the sliding door which is arranged above the upper guide being formed from glass or another essentially transparent material. In particular if this completely or partially transparent panel is then also designed with an essentially exposed upper edge, the result is an elegant construction which has a substantially less constricting effect on the passengers than constructions in which a frame region is provided on the upper edge.

The upper guide can preferably have a guide profile, in particular preferably in the form of an H profile, which is arranged on the rear side of the fixing part and is fastened to the fixing part and engages in a slot of a guide profile which is configured as part of the sliding doors and is in the form of a sliding rail. In other words, the slot of the profile is open toward the platform region. In addition, it has proven correspondingly advantageous to close said slot with sealing lips in order to avoid jamming or soiling.

Among the problems of constructions of this type is the fact that there are electric potential differences between the train and the platform region. Accordingly, a comprehensive insulation of the platform region with respect to the rails, which are normally used to ground, is enormously important. The sliding door construction is accordingly to be insulated as well as possible with respect to the floor of the platform. This can be achieved according to the invention by a special configuration of the base plate on which the stationary regions are arranged or which forms part of the stationary region.

It must be pointed out that said specific configuration or the manner in which such a base plate is assembled has an inventive character irrespective of the abovementioned sliding door construction and is therefore also patentable independently thereof.

A construction of this type is characterized in that the stationary regions are each fastened, with the aid of anchor bolts or pins, to the floor of the passenger region via at least one base plate which is provided with an insulation layer covering the entire surface. The insulation of the entire surface of the base plate leads to, for example, dirt or moisture arranged on the floor not being able to lead to electric contact between the floor and the base plate or the stationary construction arranged thereon being able to take place.

This can be achieved particularly effectively if the insulation layer covering the entire base plate is composed of a synthetic material, in particular preferably of a thermoplastic polyamide, for example PA11, and is designed with a thickness in the region of 0.2-1.5, preferably 0.25-1 mm.

A first preferred embodiment of a base plate of this type is characterized in that the base plate has fastening holes which have a substantially larger diameter than the anchor bolts or pins (typically diameters of the bores are 2-5 times greater than the diameter of the bolts or pins with which the plate is fastened on the floor), and in that an insulating filling material, in particular of plastic or resin, such as, for example, acrylic resin, is arranged for the transmission of shearing force and for a positive-locking connection between base plate and anchor bolts or pins. The resin is preferably mixed in such a manner that it, firstly, has the required strength and, secondly, is brittle enough that it can be removed again if the entire structure has to be replaced.

By means of this construction, it can firstly be ensured that tolerances between the pattern of holes for the bolts or pins in the floor can readily be absorbed, and, in addition, it can be ensured that the bolts or pins which are in electric contact with the floor do not come into electric contact with the ground of the base plate. In order, subsequently, not to obtain any contact connection during assembly, it has proven advantageous to provide insulating elements (also in the form of spacers) between base plate and floor and between the fastening means by means of which the base plate is subsequently fastened by the bolts or pins. If pins are used, they are preferably provided with a thread at their upper end, and nuts are screwed onto said thread in order to fasten the base plate.

In conjunction with a sliding door construction of this type, it is advantageously possible that at least one of the stationary regions has, in the region of its upper edge, in particular preferably at least partially integrated in a covering bounding the upper edge of the respective stationary region, means for the indirect illumination of the passenger region.

This possibility of illumination is independent of the abovementioned specific design of the sliding door construction if the sliding door construction is at a height in the region of less than the overall height of the passenger region. This possibility of illumination is particularly advantageous if the stationary regions are at a height in the region of 1.7-2 m above the floor of the passenger region. This is because, then, indirect illumination is possible in an optimum manner via an illumination of the ceiling region of the passenger region without the people in the passenger region being dazzled.

This specific arrangement of light sources on the upper edge of the stationary regions is advantageous, inter alia, since means for supplying electric power are already provided in the region of the sliding door construction, since the illuminating means are arranged at a height which substantially simplifies the maintenance of the illumination (for example cleaning or interchanging of lamps, this is generally associated with a very large outlay if lamps are arranged on the ceiling), and since the indirect illumination gives rise to a generous sensation of space, which is essential in particular in subway stations.

The means for the indirect illumination of the passenger region can be known lamps which form an essentially upwardly directed or at most vertically oriented tone of light. For example, reflected light sources, such as neon tubes, but also LED light sources, flood lights, in particular halogen flood lights etc., typically with a light intensity per light source of preferably more than 10000 lumens, are possible, and the lamps can additionally have means for focusing light or widening it in a specific manner. The tone of light therefore preferably forms, for example, an angle in the region of 0-90 or, better, 0.45° with the vertical, since it is thus ensured that passengers are not disturbed by the direct light. This tone of light provides indirect light from the ceiling for the passenger region, since the illuminated ceiling reflects the light.

In order to further improve the indirect illumination of the passenger region or to orient it in a specific manner, it is possible to arrange further means for better indirect illumination of the passenger region on the ceiling (or in general above the light source). Of course, means of this type can also be arranged for illuminating the track region in a specific manner.

These further means are, for example, one or more reflectors (which can be oriented differently), in particular preferably in the form of mirrors, which are fastened, for example, to the ceiling.

A particularly versatile construction is possible if the means for the indirect illumination of the passenger region are fastened in the region of the upper edge of the stationary region in such a manner that the tone of light generated by them can be adapted to correspond to local requirements, with, in particular, a setting of the direction of the tone of light in a direction perpendicular to the direction in which the platform runs preferably being possible by rotation of the means designed as a lamp about an axis essentially parallel to the direction in which the platform runs.

In conjunction with a sliding door construction of this type, it is furthermore advantageously possible if display means for conveying information to people in the passenger region are arranged in at least one of the stationary regions (or else on one of the sliding doors). Said display means can convey the information indirectly (for example can be a projector which projects onto a projection surface on the ceiling or the wall or on the rear side onto a surface of the stationary region), or they can provide the information directly. In other words, the display means can involve at least one display means selected from the following list: LCD screen, LED display, projector, illuminated script, illuminated sign, advertising placard (also rolling placard), said display means preferably providing information in time-varying form.

It is to be emphasized that said display means can be directed both toward the passenger region and toward the track region, i.e. to the rear to a certain extent.

If the display means are directed toward the passenger region, the information is conveyed directly to the people who are in the passenger region arranged in front of the sliding door construction. If the display means are directed toward the track region, i.e. to the rear to a certain extent, then the information displayed there can be received either by people who are on the opposite platform (i.e. if no train is on the tracks and there is a view through the transparent regions of the sliding doors, for example), or else by people who are in an arriving train and look outward through the window of the train, with it being possible for them to be either passengers or staff. Furthermore, it is possible for the display means to be provided in the stationary wall elements between the sliding doors and the stationary regions thereof, in which the suspension means for the sliding doors are arranged.

This possibility for conveying information is independent of the abovementioned specific design of the sliding door construction if the sliding door construction is at a height in the region of less than the overall height of the passenger region.

Very particularly ideally, such a display means can be arranged in at least one of the stationary regions if the stationary region has at least one transparent surface, such as, in particular, preferably a glass surface, which faces the passenger region, and if the display means is arranged with respect to the passenger region behind said transparent surface. It is thus possible, for example, to arrange one (or more) LCD screens at least at eye level in the region of 100-200 cm above the floor behind the glass surface of the stationary region.

As a result, the information is conveyed at the correct height and at a location at which the passengers in any case look when waiting for the train. In addition or alternatively, it is possible to arrange preferably variable advertising over at least half of the height of the stationary region behind said transparent surface. This can likewise be LCD advertising, but it is also possible to provide unchangeable advertising or, for example, rolling advertising or differently configured, time-variable advertising. For example, it is also possible to fit a partially transparent information carrier onto the transparent surface from behind and to illuminate it on the rear side.

In particular if the stationary region has an encircling frame, it is possible to arrange the display means on or in said frame on the side facing the sliding door or at the top of it. This has proven successful in particular for warning messages or status messages (for example arrows, for example in the form of LED signals, which are directed toward or in the opposite direction to the sliding door when the sliding door begins to close or to open). Means of this type are then preferably provided essentially over at least ½ of the height of the stationary region.

The display means typically convey information selected from the following list: advertising, news, sports events, timetables, current information about the trains for the platform and of the entire network, (interactive) Internet information, photographs, warning messages, entertainment, said information also being provided in combined form sequentially and/or in parallel and, preferably, in time-varying form.

Furthermore, the present invention relates to a method for assembly (also retrofitting) of sliding door constructions of this type. The method is characterized, in particular, in that drill holes are provided in the floor (for example in the direct pattern using a template), and in that anchor bolts or pins are then fastened in said drill holes, said bolts or pins protruding to a sufficient extent upward over the floor. The bolts or pins can be screwed or cast in. Subsequently, insulating spacer disks (in the sense of plain washers, for example made of plastic or another insulating material) are placed onto the anchor bolts or pins. A base plate with correspondingly provided bores is then placed over the anchor bolts or pins protruding above the floor.

The base plate may also be recessed in the platform floor.

In this case, as already mentioned further above, the bores have a diameter which is substantially larger than the diameter of the bolts or pins. The intermediate spaces between the bores and the anchor bolts or pins are subsequently filled with insulating filling material, and, after further insulating spacer disks (for example, plain washers as already mentioned above) are placed on, the base plate is fastened with the aid of nuts or the like. The assembly of the stationary regions is preferably already screwed or the like onto the base plate (for this purpose, threaded bores, in the form of blind holes, can already be provided in the upper surface of the base plate), with it being ensured that there can be no contact with the floor. Therefore, after the anchor bolts are fitted into the platform, the entire structure (fixing part), which has already been preassembled and tested at the factory (fixing part including sliding leaf are entirely fitted and commissioned at the factory), is screwed on.

Further preferred embodiments of the sliding door construction according to the invention and of the method according to the invention for assembling a sliding door construction of this type are described in the dependent claims.

### BRIEF EXPLANATION OF THE FIGURES

The invention will be explained in more detail below with reference to exemplary embodiments in conjunction with the drawings, in which:

FIG. 1 shows a) a perspective view of a sliding door construction according to the invention, b) a view of a closed sliding door construction from the platform side, c) a view of a closed sliding door construction from the track side, d) a view of an open sliding door construction from the platform side, together with a corresponding horizontal projection arranged therebelow;

FIG. 2 shows a) a section through a sliding door construction over the entire height, b) a detail of the base region from a section according to a), c) a view of the driving region of the fixing part from the track side when the sliding door is closed, d) a view of the driving region of the fixing part from the platform side when the door is closed, e) a perspective view of the driving region (possibly present housing removed), f) a detail of the head region from a section according to a);

FIG. 3 shows a) a detail of the base region with the base plate, b) a detailed view of a bore with filling, c) a base plate in plan view, d) a schematic sectional illustration of a platform perpendicular to the direction in which the tracks run, e) a schematic illustration of the force ratios in the floor region, f) a view from above of a platform with the reinforcement according to the invention, g) a section through a reinforcement of this type vertically and in a direction parallel to the direction in which the tracks run, h) a reinforcing construction in an exploded view;

FIG. 4 shows perspective views of a different exemplary embodiment, with a) the illustration illustrating the closed state and b) the open state;

FIG. 5 shows a detailed section through a possible upper guide arranged halfway up the sliding door;

FIG. 6 shows a section perpendicular to the direction in which the tracks run, through a closed platform region, for example subway;

FIG. 7 shows a section according to FIG. 6, with reflectors additionally being arranged on the ceiling;

FIGS. 8a) and b) show different possibilities of integrating a lamp in the upper covering of the stationary region; and

FIG. 9 shows a schematic illustration of the different possibilities of arranging display means for conveying information to the passengers in a cutout of a sliding door construction.

### WAYS OF IMPLEMENTING THE INVENTION

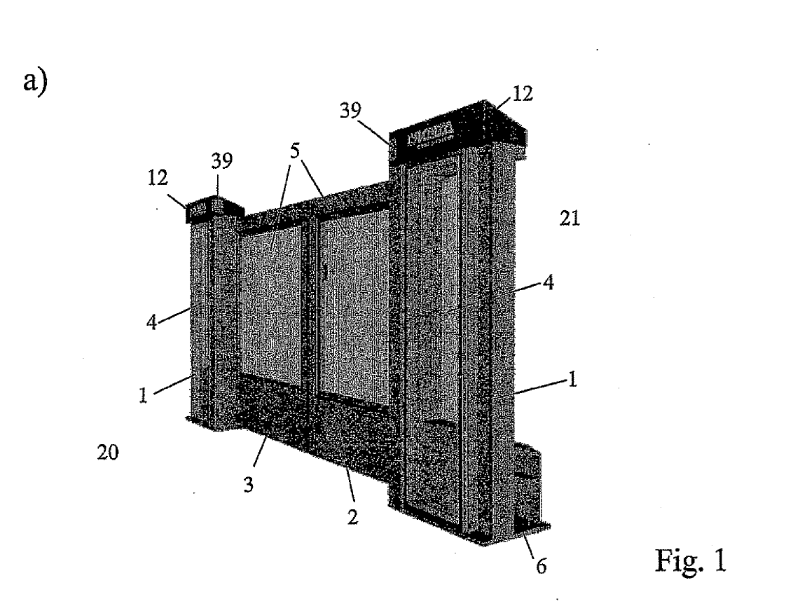

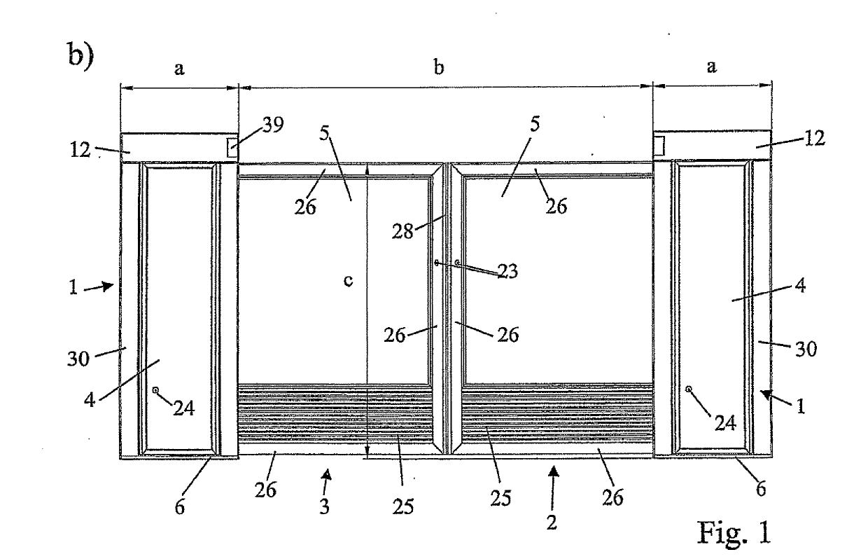

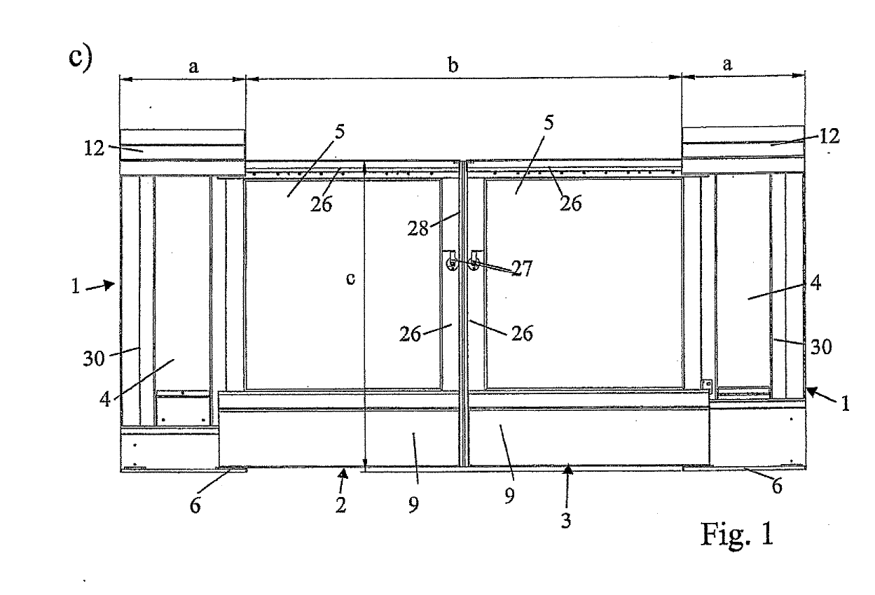

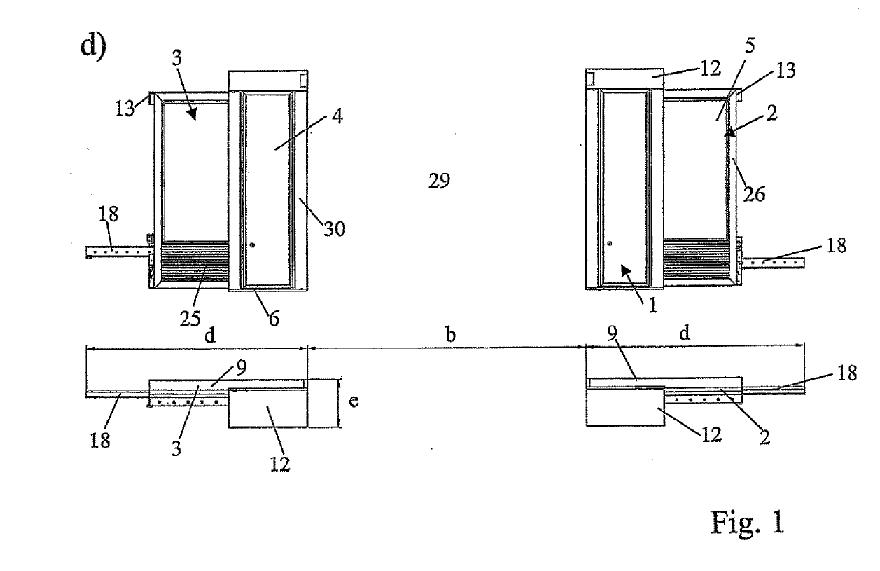

FIG. 1a) shows, in a perspective view, a sliding door construction which is to serve as an exemplary embodiment to illustrate the present invention. However, the exemplary embodiments which are described below are to be used only for illustration but not to restrict the scope of protection as defined in the patent claims.

A sliding door construction of this type basically comprises fixing parts 1 which are arranged on both sides of the actual door opening. The door opening is closed by two sliding doors 2 and 3, with it also being possible, as an alternative, to arrange just one sliding door. The two sliding doors 2 and 3 close synchronously and in opposite directions. Sliding door constructions of this type are accordingly arranged on the edge of the platform. However, the sliding door constructions do not directly follow each other, but rather further wall elements which do not constitute a door opening are arranged between sliding door constructions, one of which is illustrated in FIG. 1a). Wall elements of this type are typically likewise of similarly transparent design. Said wall elements are required, inter alia, since otherwise the doors 2, 3 would strike against each other during the opening operation.

The fixing parts 1 comprise a base plate 6 on which the upper construction is fastened in each case. The upper construction essentially in each case comprises a frame 30 which is bounded in the head region by a covering 12. Lamps 39 are arranged in the covering and serve to emit optical signals, for example by flashing, for the passengers during the opening operation or during closing of the doors 2, 3. For aesthetic reasons, a transparent region 4, for example, is arranged in the frame of the upper construction of the fixing parts 1. Furthermore, each of these upper constructions comprises a mounting for the doors 2, 3, which mounting will be described in detail further below, and a drive.

In addition, at least one fixing part per sliding door construction comprises a controlling means which is connected, inter alia, to an overall controlling means of the entire system of sliding doors on a platform so that a coordinated opening operation or closing operation of all of the sliding doors at the correct moment, i.e. at the correct position of the train, can be ensured. The sliding doors 2, 3 are also partially equipped with transparent regions 5.

FIG. 1b) illustrates a sliding door construction of this type in a view from the platform side. It can be seen in this case that the fixing parts 1 each comprise a frame 30. A transparent region 4 is arranged in each case within said frame. Said transparent region is designed as it were as a door which can be opened in order to render the functional parts located behind it, such as, for example, the drive and suspension means and controlling means, accessible for maintenance or installation. For this purpose, these transparent regions 4 are provided with a lock 24.

The sliding doors 2, 3 for their part likewise comprise an encircling frame 26. A sealing lip 28 is arranged on said frame at the point at which the sliding doors border each other. Sealing lips 28 of this type are preferably configured in such a manner that the sealing lips 28 of doors bordering each other engage one inside the other. Furthermore, there are transparent regions 5 in said frames 26. However, said transparent regions 5 do not extend entirely as far as the floor, since there is a respective panel region 25 in the lower region, as a consequence of the suspension means arranged therebehind.

In principle, the sliding doors cannot be opened from the platform side by simple manipulations. However, in order to permit mechanical opening of the sliding doors 2, 3 in the case of an emergency, emergency opening possibilities 23 are provided, but they can only be actuated with the use by the staff of an appropriate key. The two sliding doors 2, 3 are of self-supporting design, i.e. a small gap which is typically in the region of 5-30 mm remains between the floor and the lower edge of the door.

A fixing part 1 has, for example, an entire width a of circa 600 mm at maximum, and the door opening can have a width b of 2100 mm. In principle, door opening widths b in the region of up to 2500, normally of up to 2200 mm, are possible. The width of the door openings can be adapted in accordance with requirements, and this is possible without the construction of the fixing parts 1 having to be changed. Thus, a construction is possible which can be installed without major adaptations to the local conditions. The sliding doors 2, 3 have a height c such that the upper edge of the sliding doors 2, 3 is arranged circa 1500 mm above the floor. Normally, such doors are constructed with heights in the region of 1000-2000 mm.

FIG. 1c) shows a view of a sliding door construction of this type from the track side. It can be seen in this case that the actual suspension means of the sliding doors is concealed behind the panels 25 (compare FIG. 1b). Said suspension means is covered by a covering 9 such that soiling of the suspension means can be avoided and such that the passengers cannot grab it.

Since, in emergency situations, it may be necessary, under some circumstances, for passengers in the train to open sliding doors 2, 3 of this type manually, handles 27 are provided on this side of the doors and can be used to open the sliding doors 2, 3. Said handles 27 are typically configured in such a manner that, upon manipulation and when current is still present, they trigger an opening of the doors in an automated manner, and that, however, if there is no longer any current, they likewise permit the door to be opened with the application of force.

FIG. 1d) shows a sliding door construction of this type in the open state from the platform side, and an associated horizontal projection immediately therebelow. It can be seen in this case that, owing to the substantially smaller width of the fixing construction 1, the sliding doors 2, 3 protrude laterally over said fixing parts 1. Specifically, each sliding door has an entire width d including suspension means of circa 1700 mm (depending on the clear width of the doors), since, owing to the self-supporting configuration, they have a guide rail 18 which protrudes to the rear over the actual width of the door. In addition, it is essential in this connection that the overall construction depth is not too great so that the required space does not take up too much platform area. The proposed construction is distinguished by a very small construction depth, and so, with the abovementioned basic dimensions, the construction depth e of circa 300 to 400 mm is possible.

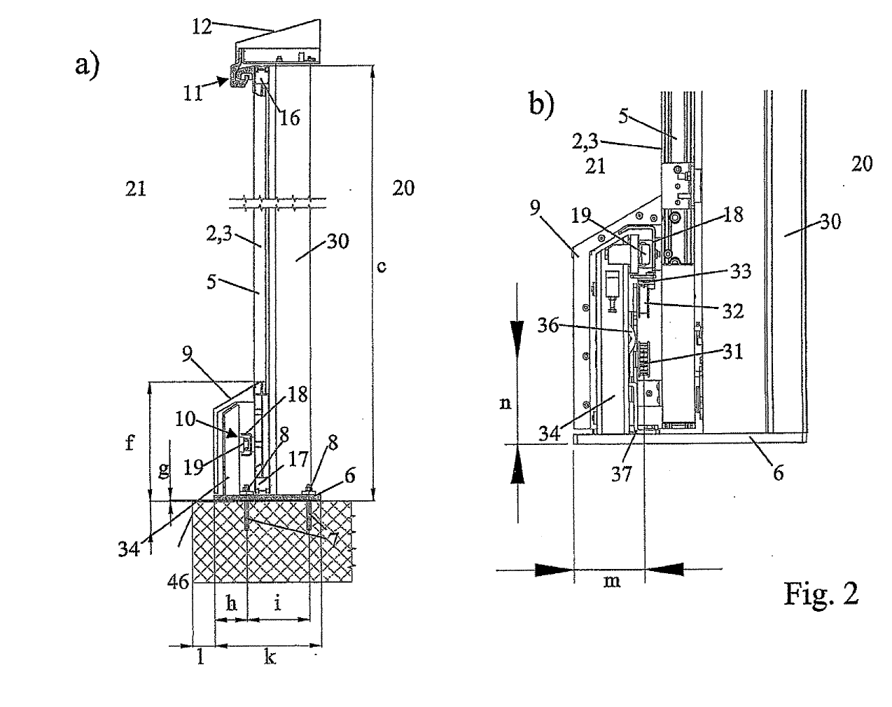

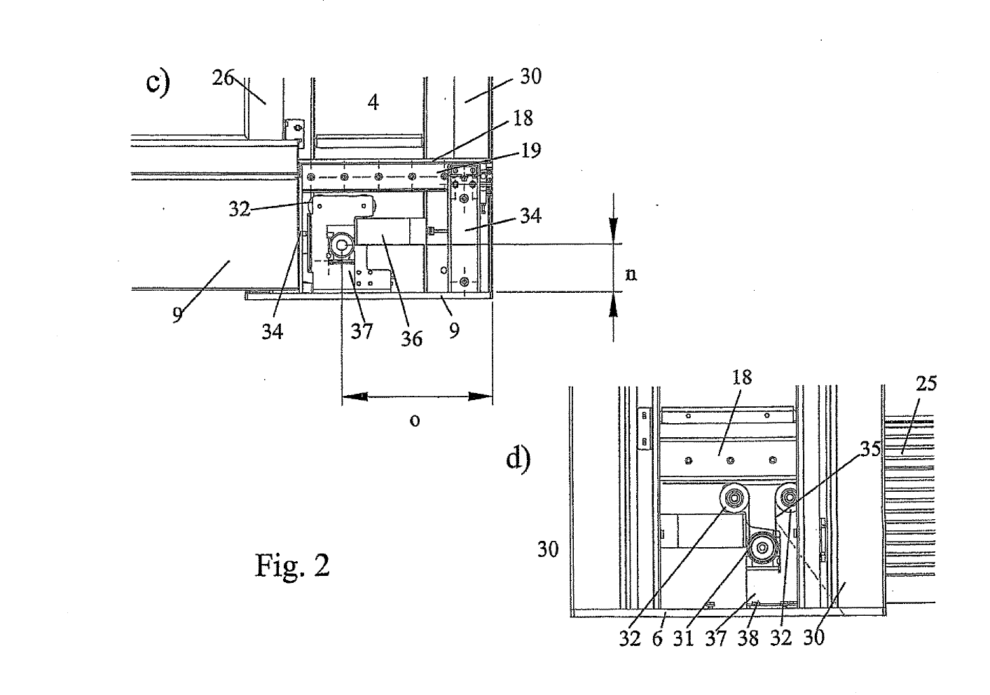

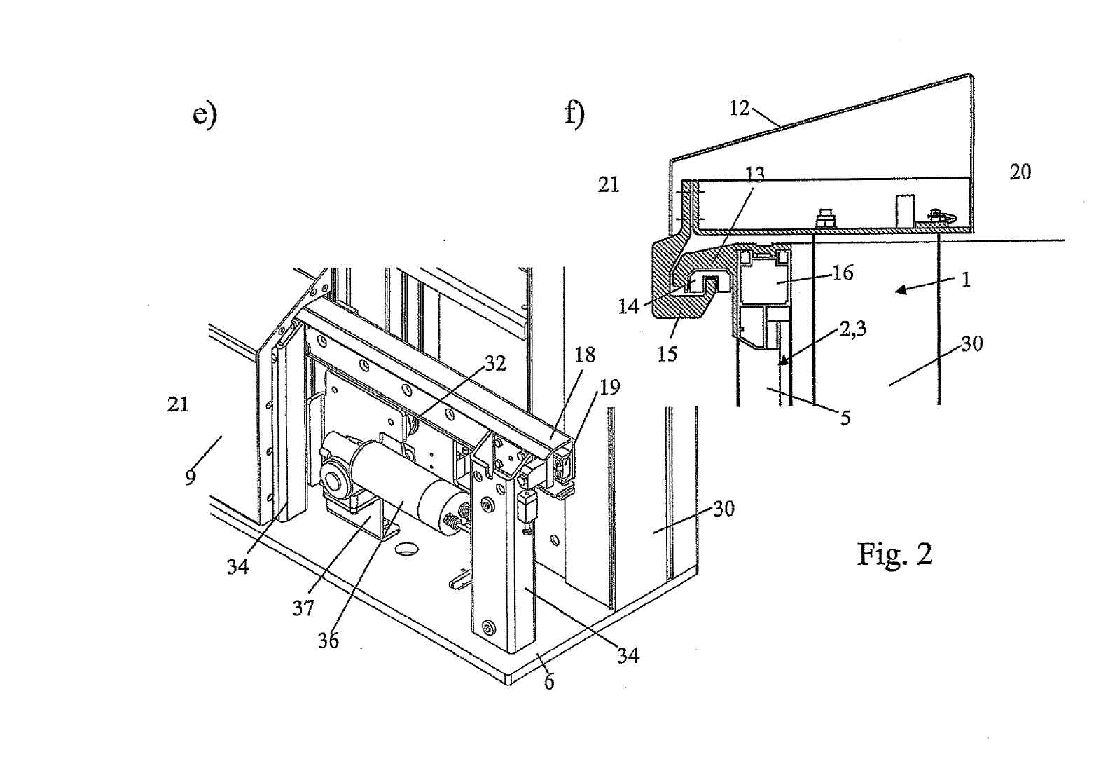

FIG. 2a) shows a section through a sliding door construction of this type. It can be seen here how there are two suspension means 10 and 11, the two suspension means being arranged on the train side 21 and not on the platform side 20. The upper suspension means 11 is essentially arranged in the region of the upper edge of the sliding doors 2, 3 and is described in detail further below.

The lower suspension means 10 is arranged in the lowermost region of the sliding doors 2, 3. The sliding doors 2, 3 have a covering 9 behind which the suspension means 10 is concealed. The suspension means 10 comprises a stationary part in the form of a guide element 19 which is arranged on the fixing part 1. A guide rail 18 which, together with the guide element 19, forms a roller bearing or a ball bearing (e.g. ball bearing cage) via which the respective sliding door can be displaced laterally is fastened to the respective sliding door.

The height f of the panel region 25 or of the covering 9 above the floor is circa 400 mm, and the base plate 6 is spaced apart from the floor at a distance g of circa 5 mm. The base plate 6 has a depth k of circa 360 mm and, for safety reasons, is typically set back from the platform edge 46 by a distance 1 of circa 75 mm. This value is project-specific and dependent on the structure gauge of the train. The base plate is anchored in the floor with two rows of anchoring elements 7, the first row of anchoring elements being offset from the rear edge of the base plate 6 by h in the region of 110 mm, and the two rows of bolts being spaced apart by circa i=210 mm.

The driving region is illustrated in detail in subsequent FIGS. 2b)-e). A sectional illustration is provided in FIG. 2b). It is apparent from this that a horizontal guide element 19 is fixed to the fixing part at supporting pillars 34 fastened on the base plate 6. Said guide element 19 has a width which is always smaller than the overall width of the fixing part 1. The actual drive which is ensured via a horizontally arranged electric motor 36 is likewise fastened on the base plate via an assembly plate 37. The electric motor 36 has, for example, a worm gear which drives a toothed-belt driving roller 31. Furthermore, toothed-belt deflecting rollers 32, which will be discussed in conjunction with FIG. 2d), are arranged above said toothed-belt driving roller 31. In order to fasten the toothed belt 35, either a driver is provided, in the case of a revolving toothed belt, or else a fastening device 33 is provided on the guide rail 18.

FIGS. 2c) and d) show two views of the driving region from the train side and the platform side, respectively. It can be seen that, on the angled assembly plate 37, which is fastened on the base plate 6 by means of assembly bolts 38, the toothed-belt driving roller 31 is arranged at the bottom and two toothed-belt deflecting rollers 32 are arranged above it in a manner set laterally symmetrically.

In this exemplary embodiment, the toothed belt 35 is fastened at its ends to the guide rail 18, and is in each case deflected from each side from above via the toothed-belt deflecting roller 32 downward to the toothed-belt driving roller 31. The tension of the toothed belt 35 can be set either by lateral displacement of the toothed-belt deflecting rollers 32 or via a horizontal adjustment of the toothed-belt driving roller 31 (also possible in each case via a spring-mounted mounting with countertension). This specific arrangement of the individual elements, i.e. horizontal driving motor with worm gear, toothed-belt driving roller 31 with deflection via two toothed-belt deflecting rollers 32, permits a particularly compact construction, and the use of a toothed belt for the drive has proven particularly robust.

It is apparent from the perspective view according to FIG. 2e) that the supporting pillars are preferably designed as a hollow profile, with the guide element 19 being fastened thereto from the platform side. It is possible in this case to arrange two individual guide elements 19 on the two supporting pillars 34, or else, and this is illustrated in FIG. 2e), it is possible to design said guide element 19 likewise as a rail in which individual bearing elements are distributed. The guide rail 18, which is fastened to the sliding doors 2, 3, is configured as a double U profile, with the inner U profile engaging around the guide element 19 for guidance purposes and therefore the inner U profile serving as the running surface, and with the outer U profile being provided to engage around the guide for protection thereof.

The upper guide 11 is better apparent from FIG. 2f). An upper door profile 16 which forms part of the frame 26 is arranged on the upper edge of the sliding doors 2, 3. A guide-profile rail 13 is fastened to said upper door profile 16. Said guide-profile rail preferably has a width which approximately corresponds to the width of the sliding door 2, 3, but it may also protrude somewhat to the rear beyond the door, as illustrated in FIG. 1d). As a countermove, a guide profile 15 is fastened in the upper region of the fixing part 1 as the fixing element. However, the guide-profile rail 13 does not engage directly in the guide profile 15 but rather the upper guide is designed as a telescopic guide in which a telescopic profile 14 is arranged movably between said two elements. The telescopic profile 14 is therefore displaceable both with respect to the guide-profile rail 13 and with respect to the guide profile 15. The individual elements slide on each other, i.e. the upper guide 11 is designed as a sliding guide. The use of the telescopic profile permits the guide to have a particularly large width without a clumsy guide device being necessary.

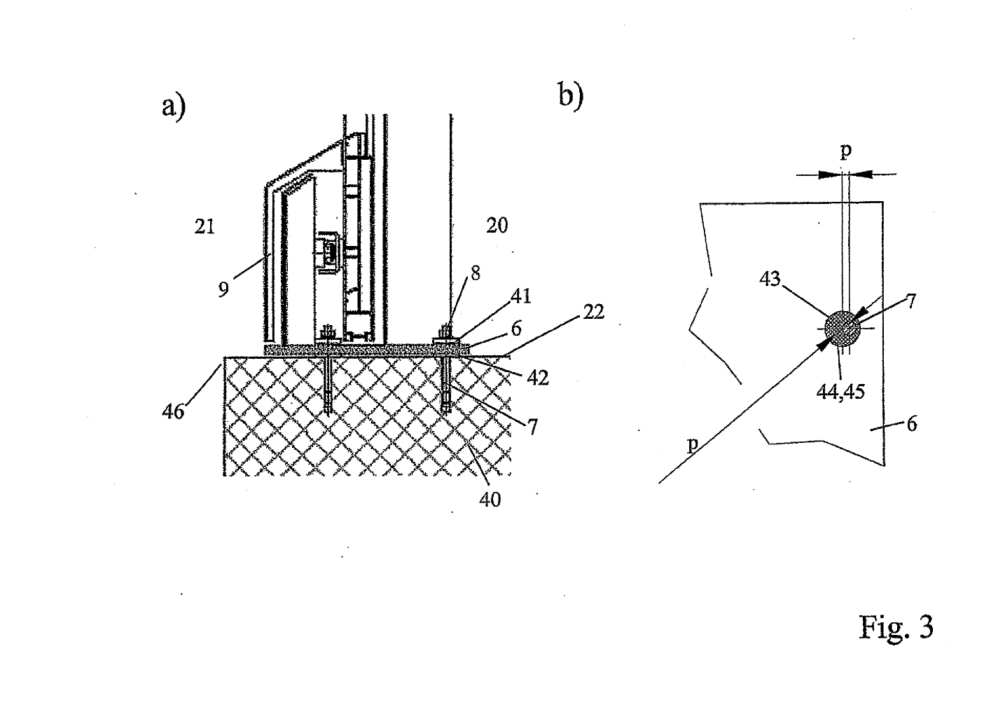

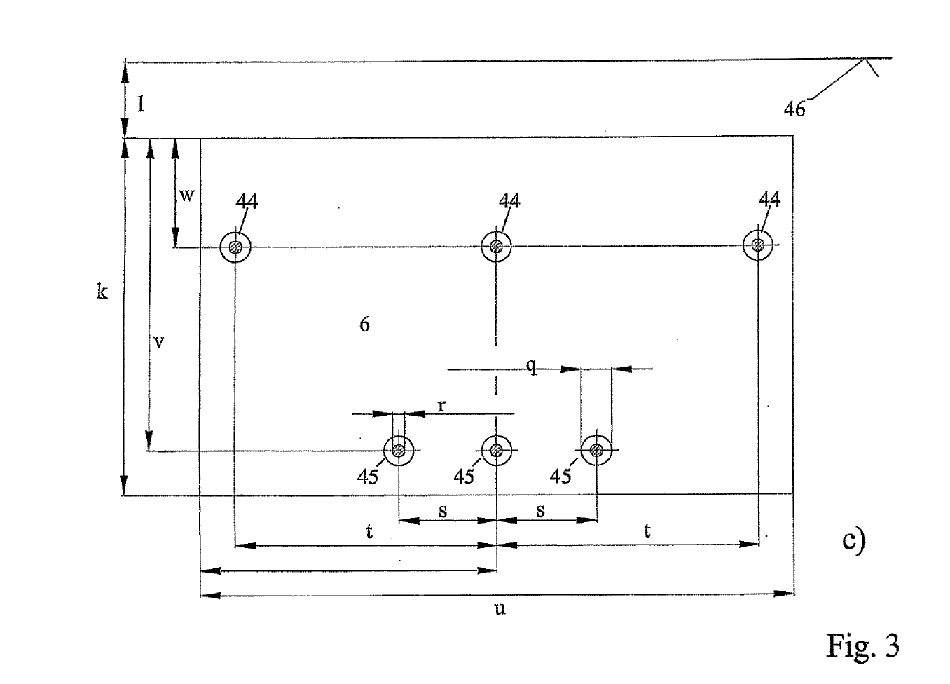

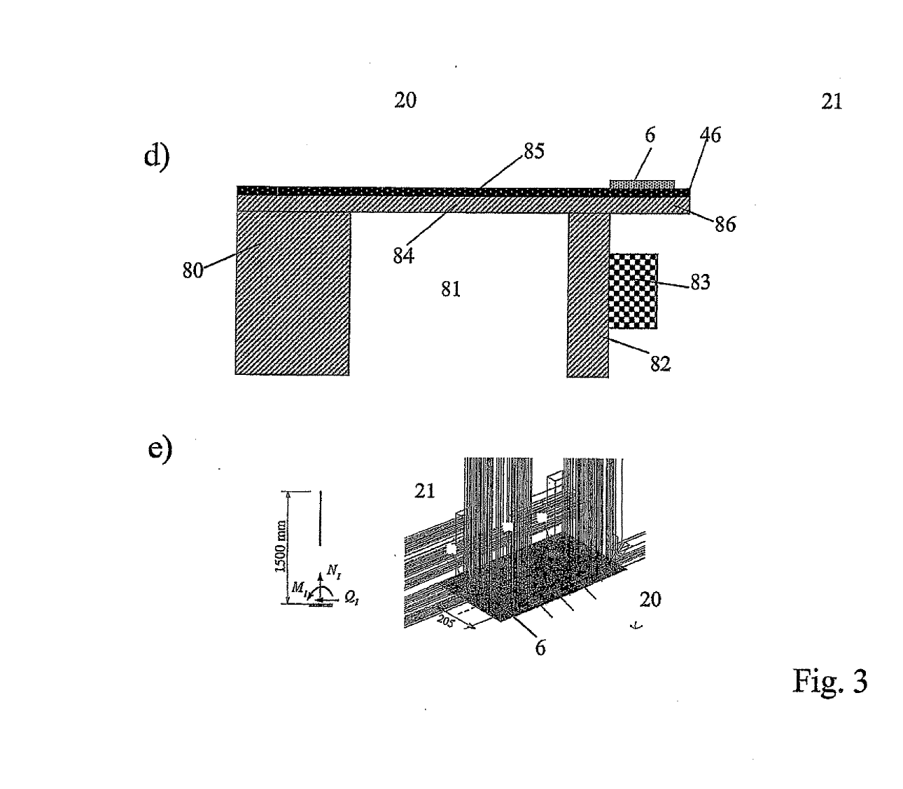

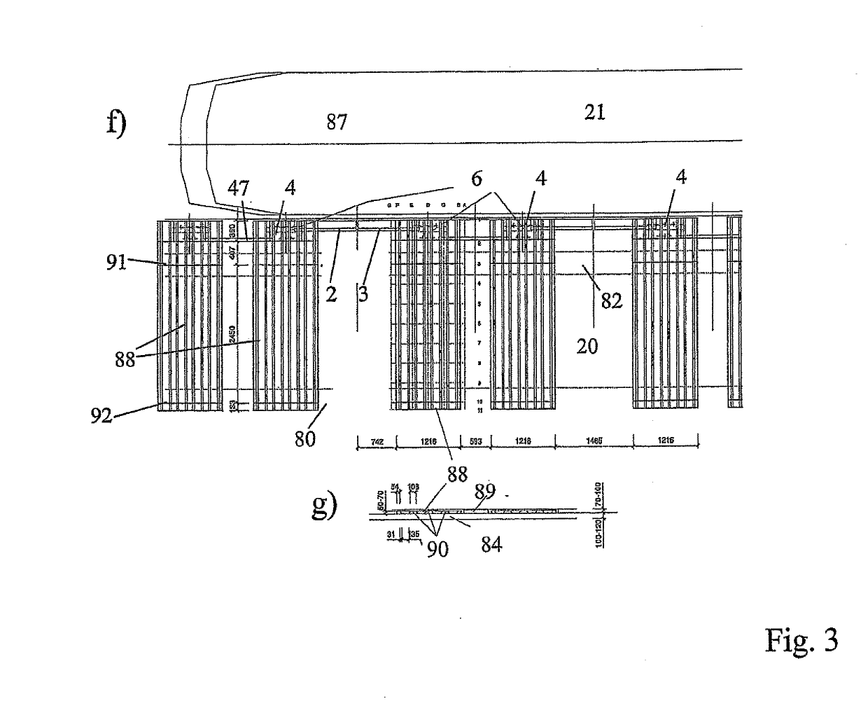

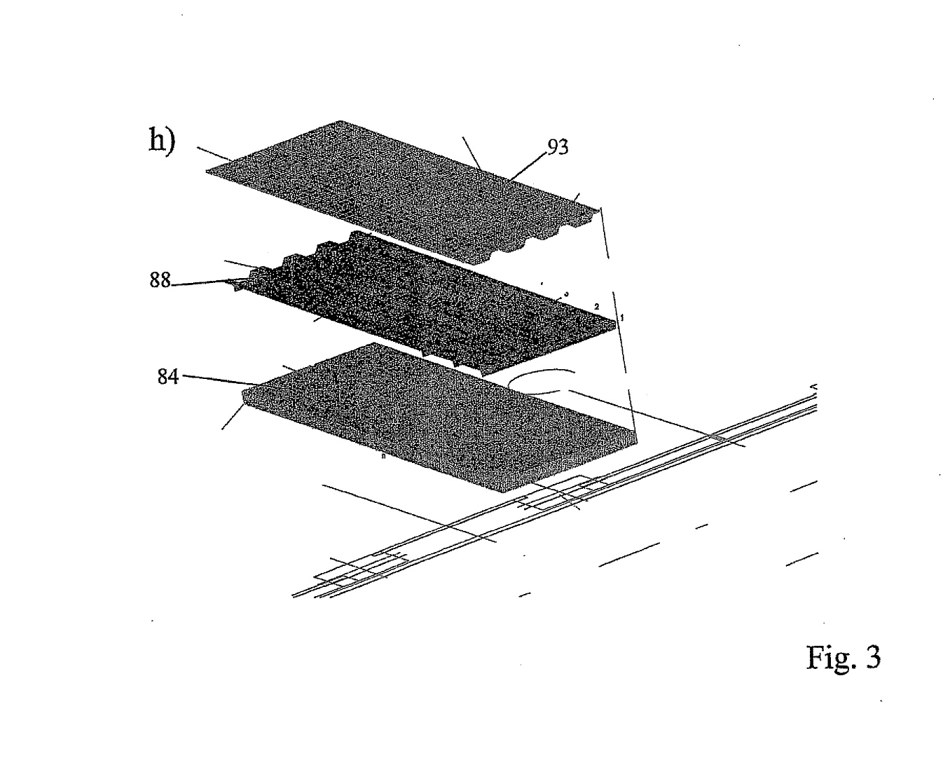

An additional essential element of the present sliding door construction is the fastening to the floor. FIG. 3a) shows, in detail, the floor region of the construction. A base plate 6 is anchored in the platform material 40 by means of fastening elements 7.

All of the elements of the fixing part 1 are subsequently fastened on said base plate 6. First of all, therefore, a base plate 6 is fastened on the platform by corresponding holes being drilled into the platform. The fastening elements are either screwed (anchor bolts) or, for example, cast (anchor pins) or the like into said holes. The base plate 6 is now placed over those ends of the fastening elements which protrude upward above the level of the floor, with the fastening elements 7 passing through bores 44, 45 correspondingly provided in the base plate 6. In addition, insulating spacer elements 42 are provided between base plate 7 and floor, with it being possible for said spacer elements to be designed, for example as illustrated in FIG. 3a), in the form of insulating plain washers 42. Insulating plain washers 41 are now likewise placed from above onto the base plate 6 and only then is the base plate fixed to the floor with the aid of nuts 8. The nuts 8 are screwed onto fastening elements 7 which are provided with a thread at the upper end.

The base plates are covered over their entire surface with an insulating coating. This involves a coating made of thermoplastic polyamide, for example thermoplastic PA11, which is configured with a thickness of approx. 0.4 mm. The material of the coating can be, for example, the product Rilsan® from Atofina (DE), and thermoplastic PA11 materials of this type can be applied, for example, by whirl sintering, by electrostatic spraying, by powder spraying or the like, with it being possible for the workpiece to be previously subjected to a surface pretreatment, for example cleaning and application of a primer or the like. In order to ensure the electric insulation effect between platform and sliding door construction, the bores 44, 45 are also configured to be substantially larger than the diameter of the fastening elements 7. After the fastening elements 7 are fastened in the floor, and the spacer elements 42 and the base plate 6 are placed on, the intermediate space between the fastening elements 7 and the edge of the bores 44, 45 is filled with an electrically insulating filling material 43, for example acrylic resin, for example acrylic casting resin Beracryl® from Troller AG. The material is preferably mixed in such a manner that it firstly has sufficient strength for securing purposes and secondly a degree of brittleness which enables it to be removed again during disassembly. The insulating effect of said filling material ensures that there will definitely be no electric contact with the floor in the region of the fastening elements. As is apparent in FIG. 3b), the design in this case is such that a sufficient circle of tolerances p of 10 to 20 mm is produced.

A base plate of this type is illustrated in detail in FIG. 3c). It can be seen how, in the region facing the platform, the fastening by means of three bolts via three bores 45 takes place more in the central region, since the two pillars 30 of the fixing part 1 are arranged in the lateral region. The three bores 44 facing the track region are widely distributed. The bores have a diameter q of 30 mm while the anchor bolts or anchor pins 7 have a diameter r in the region of 12 mm. The first row of bores 44 is offset to the rear by w in the region of 110 mm and the second row of bores 45 by 315 mm. The base plate 6 has an entire width u of circa 600 mm, with the outer two bores 44 of the first row being offset from the center by t=265 mm while the lateral bores 45 of the second row are offset by s=100 mm.

The assembly of a sliding door construction of this type proves particularly simple, since, first of all, the base plate is fastened, as described above, to the floor and, subsequently, the fixing parts 1, i.e. the upper construction thereof, can be placed on or screwed on. The fixing parts 1 are standard elements which are configured independently of the width of the sliding doors. Between the fixing parts, wall elements are now provided in the closed regions, which wall elements merely have to be adapted in terms of their length, which can take place either by the customer or already beforehand. The sliding doors 2, 3 can subsequently be suspended from the track side, and, finally, the toothed belt 35 merely has to be placed around the corresponding elements 31 and 32 and tensioned. The controlling means can be designed in such a manner that it is self-learning, which means that, when first switched on, measuring and setting of the opening operation take place automatically.

An important point regarding installation is the fact that the entire fixing structure including door leaf can already be fitted and tested at the factory. On the platform, only the bolts actually have to be installed into the platform and, after that, the entire fixing structure placed thereon. The cables are laid beforehand and immediately connected as soon as a fixing structure is fitted. From this instant, the doors can automatically open and close (this is necessary in particular during retrofitting at night, since the trains are already running again the next morning). This also means that, during the installation phase, the doors which are already installed already function automatically all day.

The supporting construction substance of platforms has sometimes been prepared a very long time in the past. The construction of platforms has normally scarcely been changed in the past and is therefore generally not suitable for absorbing the additional stresses when a sliding door construction is installed. Although the fastening with the aid of the base plate 6 can be of some assistance here, there are a multiplicity of situations in which the retaining force cannot be taken on by the floor construction.

A typical situation is illustrated in FIG. 3d). A platform is normally constructed on a substructure comprising a rear wall region 80 and a front wall 82. There is normally a non-supporting cavity 81, which can be filled, for example, with sand, between said two supporting elements. A concrete slab 84 rests on the rear wall region 80 and the front wall 82 and forms the actual supporting construction. A soft lining 85 (for example asphalt) is generally provided on said concrete slab 84. The generally soft lining 85 normally does not take on a supporting function but rather additionally loads the concrete slab 84.

The base plate 6 is normally placed on said lining 85 and connected to the concrete slab 84 by anchor bolts. A problem in this case is that the projecting region 86 of the concrete slab 84 is generally not capable of absorbing the forces which bear on a system of this type. Said forces are illustrated in FIG. 3e). It has been shown that, in the case of a sliding door of circa 1.5 m in height, the following moments or forces prevail: M₁=+/−4972 Nm; Q₁=+/−4200 N; N₁=−2241 N.

Irrespective of the sliding door construction used, it has been shown that, at a typical thickness and reinforcement of the concrete slab 84, such forces frequently cannot be absorbed by said construction without further reinforcement measures being taken. The obvious option, at first glance, to provide such a reinforcement is probably always to support the region 86 from below or to reinforce the latter. However, support from below is generally not possible without major interruptions to operation, and involves the risk that installations arranged below the region 86 (for example data lines, electric lines, water conduits, etc.) will be damaged during structural measures or will have to be laid.

Accordingly, the present invention also relates to a reinforcing measure, which is independent in principle from the above-described specific sliding door construction, for platform constructions of this type and to the individual structural elements used for this.

This approach is based on the fact that first of all the upper lining 85, if present at all, is removed, since it cannot in any case take on a supporting function, and at most constitutes a further loading of the concrete slab 84 located below it.

Subsequently, as illustrated in FIG. 3f), (strip-shaped) elements are applied to the concrete slab 84 preferably over the entire depth of the platform and at least in the regions in which the base plates 6 are arranged. Said elements are capable of conducting away the forces occurring on the base plate 6 to the rear, and, in particular via an anchoring means, on the anchor plane 91 to the front wall 82 or on the anchor plate 92 to the rear wall 80 (for example via anchor bolts which protrude through the concrete slab 84 into the supporting constructions 80/82 lying below it), and, as a result, of relieving the region 86 of load. Said elements are particularly preferably metal sheets, for example trapezium plates 88, which are supplemented with fine concrete. Cavities 90 can remain therebelow. A lining 89 can subsequently be provided between the strip-shaped elements 88. It is also possible in turn to apply an upper lining on or under such a layer, for example in order to raise the general level of the platform. The masses in mm for a possible construction are provided in FIGS. 3e)-g).

The reinforcing measure therefore follows the idea of replacing the previously present upper lining, which is statically ineffective, for a sufficiently rigid and lightweight supporting construction. The abovementioned elements are therefore preferably ribbed plates of composite steel, comprising, in particular, a trapezium plate with a supplement of fine concrete.

The height of the system or of the elements 88 is normally a minimum of 60 mm. The system is fitted directly onto the supporting steel concrete 86 of the platforms. That is to say, the currently present lining of a thickness of circa 70-100 mm is removed before the assembly. If the upper edge of the platform is to be matched to the level of the upper edge of the train base, the height can be set to a correspondingly greater level.

The fixed structures (i.e. base plate and sliding door construction) are now connected to the element 88. The loads of the fixed structure are guided to the anchor planes 91 and 92 by the ribbed plates. Owing to the dimensions selected, there is a sufficiently large area available, depending on the local situation, for anchoring the forces previously.

The system can essentially be used for any type of platform.

It is particularly noticeable that the existing cavities 90 of the ribbed plate system reduce the construction weight in comparison to the current situation if no level adaptation takes place. The system is distinguished by a high degree of premanufacturing at the factory. The provision of the measure only requires part of the platform to be blocked off.

The installation of the ribbed plates takes place, for example, in the following steps:
Premanufacturing the steel ribbed plates;
If appropriate, removing the lining 85 down to the concrete, for example by cutting or the like;
Temporarily protecting the dug-out regions;
Delivering and fitting the reinforcing construction;
Filling and casting the ribbed plates with a supplement of fine concrete.

The fine concrete may be plastic-modified. This results, for example, in a compression strength of 60 MPa and a tensile bending stress of 14 MPa at a thickness of 10-20 mm.

The system does not require any breaking off of supporting components on the platforms. It therefore constitutes only a minimal invasive intervention in the historically undisturbed constructional substance which is worth preserving in terms of protecting purposes.

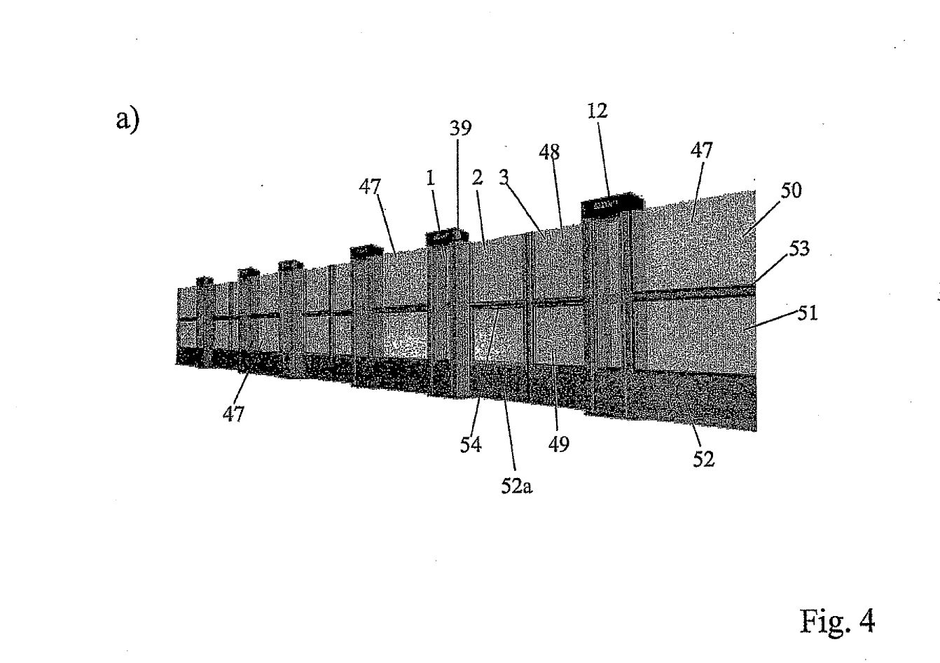

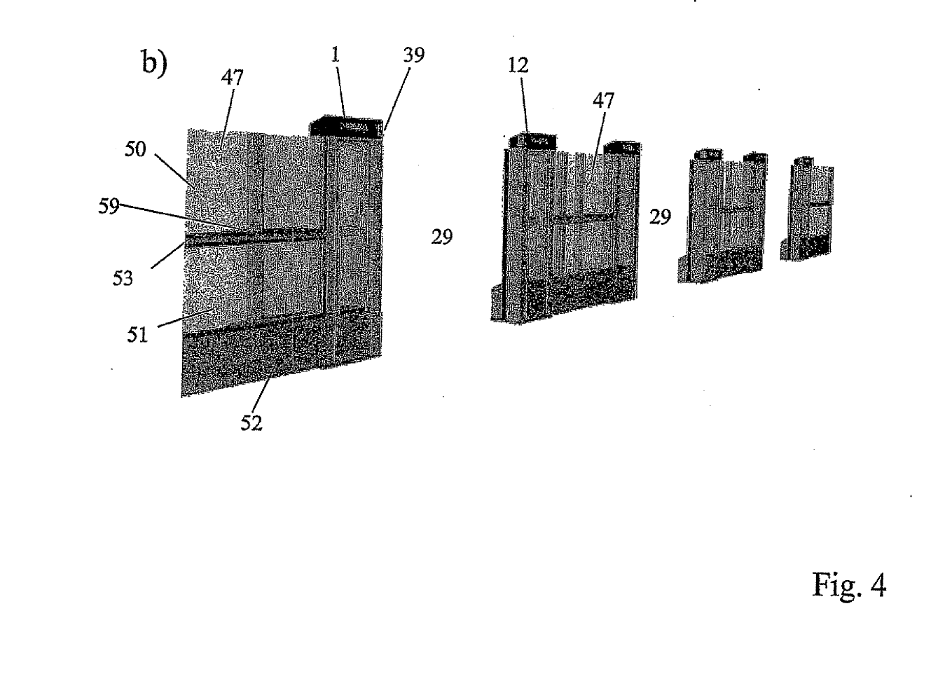

FIG. 4 illustrates a further exemplary embodiment of the invention. In this case, the upper guide is not arranged on the upper edge of the construction but rather approximately halfway up or somewhat above the sliding doors. For aesthetic considerations, it may prove advantageous to design the upper region of the sliding doors to be as transparent as possible so as to minimize the constricting effect, which occurs in particular in the case of narrow platforms, of such constructions. In the construction according to FIG. 4, the upper guide is correspondingly arranged halfway up, and respective glass panels 48 and 49 are arranged above and below it. The lower guide which is arranged in the lower region is configured in the same manner as in the above-discussed exemplary embodiment. In order to enable the entire construction to appear as uniform as possible, not only are the sliding doors 2, 3 each configured with a central guide 54 but so too are the walls 47, with said intermediate rail 53 also being able to hold an upper and a lower glass panel, as in the case of the sliding doors, or it also being possible for said intermediate rail 53 to be arranged behind a glass surface extending over the entire area above a lower panel region 52. The upper region and, in particular, the upwardly exposed, upper glass panel, which is not bounded by visually annoying frame elements, permit a particularly slender construction which is found to have scarcely any annoying and constricting effect within the visual range of the passengers.

As is apparent from FIG. 4b), in which the open state is illustrated perspectively, the upper guide 54 has an excess length which protrudes to the rear over the rear edge of the respective sliding doors. This increases the stability in particular shortly before the doors are closed.

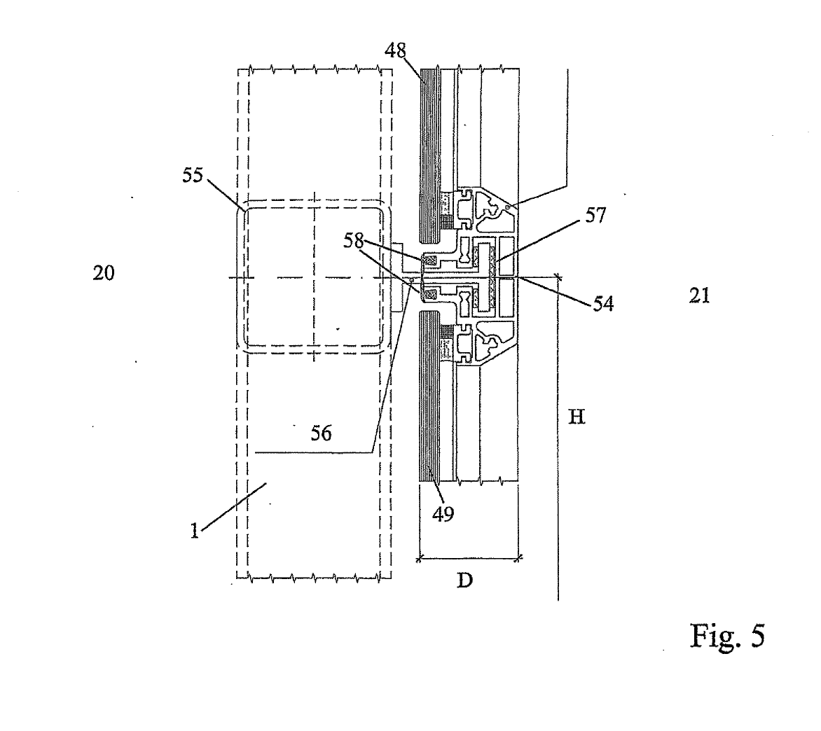

FIG. 5 illustrates a section in detail through the central guide. It can be seen here that the fixing part 1 has, halfway up, a central support 55 on which a guide profile 56 is screwed on the rear side, i.e. toward the train region. The guide profile 56 is designed as an H profile.

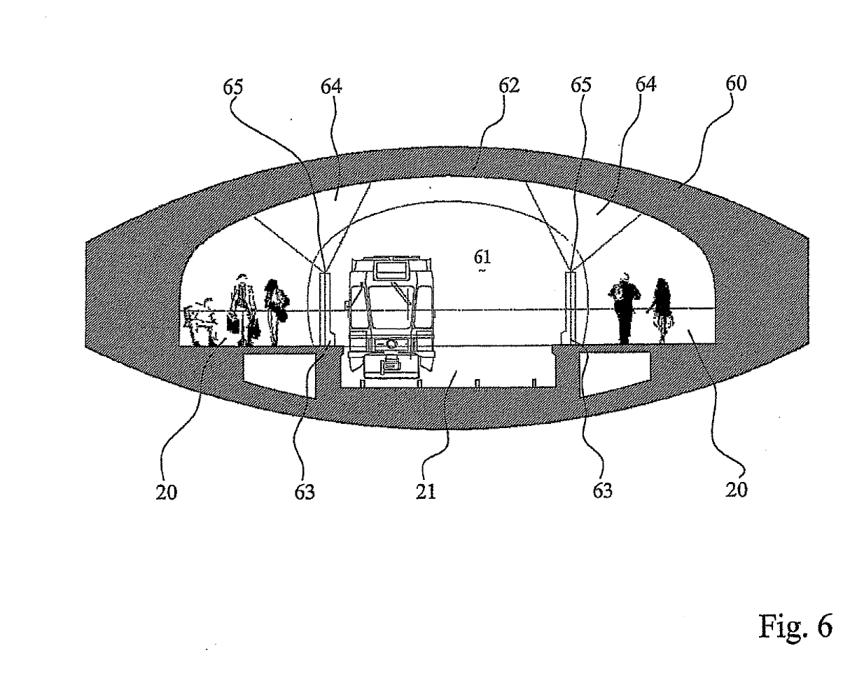

As a counterpart, the sliding door is formed from the upper and the lower glass panels 48 and 49, respectively, and said two glass panels are held in the center by the central supporting rail 54. A horizontal slot remains between the two glass panels 48 and 49, the supporting rail 54 also having a corresponding horizontal slot in which the guide profile 56 engages in the manner of a sliding guide. The guide profile has sliders 57 on its limb which faces the supporting rail 54. In the case of the exemplary embodiment according to FIGS. 5 and 6, the upper guide is not designed as a telescopic guide, and it only stabilizes the sliding doors in the horizontal direction. The support in the vertical direction is entirely undertaken by the lower guide.

Since, when the door is closed, the forwardly directed slot in the supporting rail 54 faces the passenger region, for safety reasons and in order to prevent soiling said slot should have sealing lips 58 which close the slot with respect to the passenger region when the door is closed.

The supporting rail 54 is arranged, for example, at a height H of circa 1000 mm above the upper edge of the floor, and a sliding door of this type can have a very small thickness D of circa 50 mm and nevertheless can have sufficient stability.

As already stated in the introduction, it is possible, in the case of such half-height sliding door constructions for platforms, to arrange the light sources in a sliding door construction of this type and, as a result, to avoid the arrangement of further light sources on the ceiling or at least to assist the illumination thereof.

This possibility is illustrated schematically in FIG. 6. This involves a platform which is closed all the way around, i.e., for example, involves the situation in a subway station. The platform passage is provided in the ground 60 in the form of a tunnel 61. However, the situation is the same if an upwardly closed platform is not underground.

It is now possible to arrange light sources 65 on the upper edge of the entire sliding door construction 63 (which is indicated schematically). Said light sources 65 are directed upward, resulting in a cone of light 64 toward the ceiling 62. If the ceiling does not fully absorb the incident light, the passenger region 20 is indirectly illuminated as a result.

The advantages of constructions of this type have already been emphasized in the introduction and include, firstly, the pleasant sensation of space always brought about by the indirect illumination of the ceiling 62 and, in addition, making it easier to maintain or repair a light supply of this type. Since the light supply is arranged at a height of circa at most 2 m, it is namely possible to readily interchange, clean or otherwise maintain, for example, lamps without complicated ladders, scaffolds or the like.

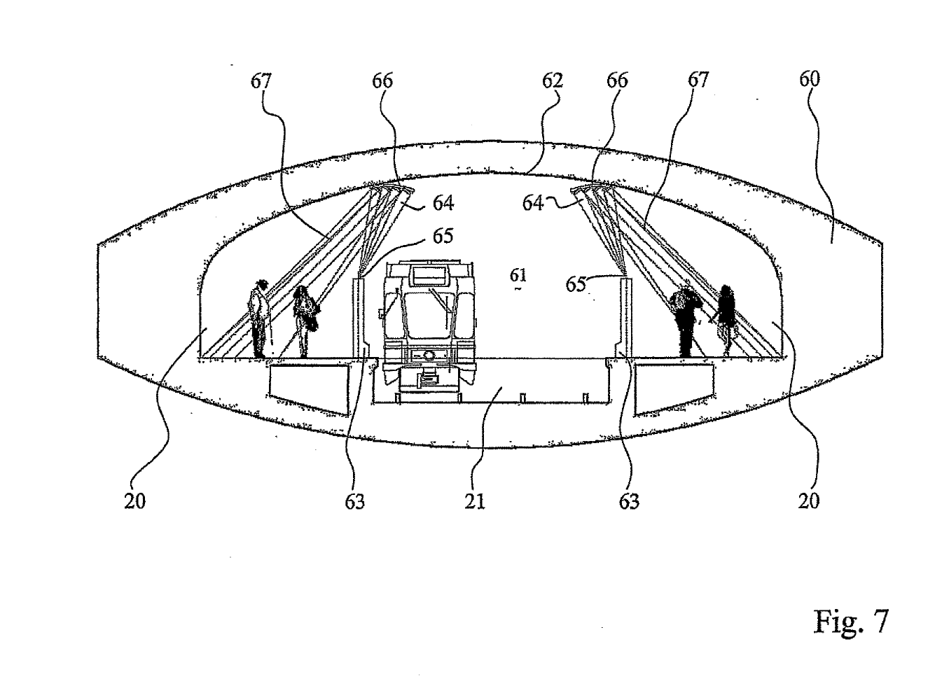

In addition, it is possible, as illustrated in FIG. 7, to undertake a targeted, indirect illumination of this type by reflectors 66 being arranged on the ceiling 62. This may involve entire groups of reflectors 66, and it is advantageous in this connection that it is possible, in particular in the case of lower constructions of the sliding door 63, to direct the cone of light 64 completely away from the passenger region 20 and thus to prevent the passengers from being dazzled. In addition, the use of entire arrays of such reflectors denotes, in particular, a highly targeted illumination of specific regions in the passenger region 20. It is possible to combine reflectors 66 of this type with indirect illumination as per FIG. 6. The reflectors 66 can be, for example, mirrors which can be oriented specifically and differently within the context of an array. The mirrors can differ in configuration, for example have a finish which is matt, shiny, beveled, etc.

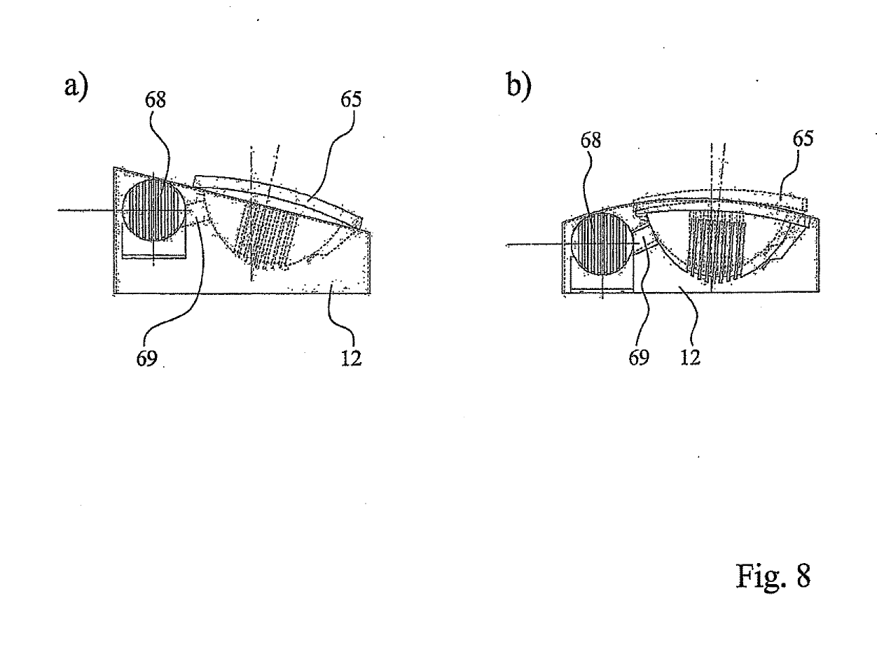

FIG. 8 illustrates how lamps 65 of this type can be integrated in a covering 12 as has already been discussed in detail further above. FIG. 8a) illustrates the possibility of integrating a lamp in a covering 12 having a planar surface slightly inclined with respect to the passenger region 20. FIG. 8b) illustrates the possibility of integrating it in a covering 12 with a convex geometry.

The lamps may be spotlights, such as reflected light sources, for example halogen flood lights, but may also be conventional flood lights, LEDs, etc. The light sources can be upwardly provided with means for focusing or for widening the cone of light. For example, it is possible, in particular when reflectors are used on the ceiling, to provide parallelizing slatted grids.

The lamps used can clearly be, for example, lamps of the type Osram HCI-EP 150 W/WDL with a light intensity of 13 000 lumens, said lamps being arranged at a height of 185 cm above the floor. It is thus possible, if at least 1-5 of such lamps are arranged per covering 12, to sufficiently illuminate a typical platform region 20 by indirect illumination.

FIG. 8 also illustrates the possibility of mounting the respective lamp head (in a covering, a plurality of lamps 65 can in particular preferably be arranged next to one another) in a manner such that it can be rotated in accordance with requirements. For this purpose each lamp or a group of lamps 65 is fastened to a rotating spindle 68 via a lever 69. The lamps can thus be oriented differently, for example within a covering 12, and account can be taken of the local light conditions.

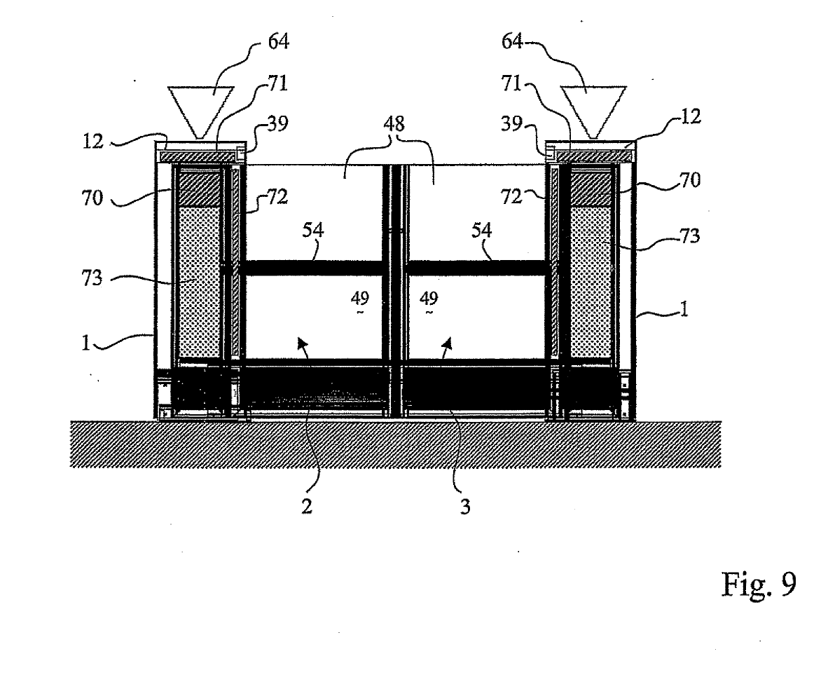

FIG. 9 shows the possibility, likewise presented in the introduction, of arranging display means in a sliding door construction. Like the possibility, already mentioned above, of arranging light sources in the region of the upper edge of the sliding door, the possibility now presented of arranging display means in a sliding door construction is also independent of the further technical features, indicated in the introduction, of the sliding door construction (in particular of the suspension means of the sliding door, etc.). It has namely been shown that it can be of great advantage to provide display means in a general sliding door construction of half height, which display means can be used to convey information to the passengers. Different regions are available for this purpose.

For example, there is a first information region A (reference sign 70) in which a screen, in particular a flat screen, can preferably be arranged behind the transparent surface present there in the stationary region 1. This is essentially at eye level and directly at the location to where the eyes of the passengers are also directed while they are waiting for the train. This is therefore the ideal positioning of a display means, for example for conveying advertising, news, information about the public means of transportation (delays, etc.).

It is also possible to provide display means over the entire height of the stationary region 1 in a further information region C (reference sign 73). It is possible here, for example, to arrange rear-illuminated advertising behind the transparent surface (glass pane), but it is also possible to simply provide a flat screen over the entire height of the glass pane, the flat screen conveying time-varying information or advertising.

A further information region B is provided in the edge region of the stationary units 1, for example, in the regions at the edge which are indicated by the reference number 72. It is possible to provide warning advice there about the status of the sliding door or, for example, also status advice, for example arrows directed toward the sliding door when the door begins to close or is in the process of closing, and/or arrows directed away from the sliding door when the sliding door begins to open or is in the process of opening. Information which is likewise operatively relevant can be provided in those regions of the upper covering 12 which are indicated by the reference number 71. For example, general warnings that the doors are now beginning to open, or similar such information, but also information about the next train to arrive, etc., can be provided there.

### LIST OF DESIGNATIONS

1 Fixing part
2, 3 Sliding door
4 Transparent region in 1
5 Transparent region in 2 or 3
6 Base plate
7 Anchor bolt, anchor pin, fastening element
8 Nut
9 Covering
10 Lower guide
11 Upper guide
12 Covering
13 Guide-profile rail on 2, 3
14 Telescopic profile
15 Guide profile on 1
16 Upper door profile
17 Lower door profile
18 Guide rail on 2, 3
19 Guide element on 1
20 Passenger region, platform
21 Train region, track region
22 Floor of the passenger region
23 Emergency opening keyhole
24 Keyhole for maintenance and cleaning
25 Lower panel region of 2, 3
26 Frame of 2, 3
27 Emergency handles on track side
28 Sealing lip
29 Door opening
30 Frame of 1
31 Toothed-belt driving roller
32 Toothed-belt deflecting roller
33 Driver, fastening of toothed belt to 18
34 Supporting pillars
35 Toothed belt
36 Motor with worm gear
37 Assembly plate
38 Assembly screws
39 Door status display, for example lamp, LED
40 Platform material
41 Spacer disk (at the top)
42 Spacer disk (at the bottom)
43 Filling material
44 Bores in 6 (front)
45 Bores in 6 (rear)
46 Platform edge
47 Wall element
48 Upper glass pane of the sliding doors
49 Lower glass pane of the sliding doors
50 Upper glass pane of the fixing part
51 Lower glass pane of the fixing part
52 Lower panel region of the fixing part
53 Intermediate rail
54 Central supporting rail
55 Central support of fixing part
56 Guide profile
57 Slider and 56
58 Sealing lips
59 Excess lengths of 54
60 Ground/rock
61 Tunnel
62 Ceiling of 61
63 Entire sliding door construction
64 Cone of light to the ceiling
65 Light source, lamp
66 Reflectors
67 Indirect cone of light
68 Rotating spindle
69 Lever arm
70 Information region A, eye height
71 Information region B, status details, at the top
72 Information region B, status details, at the side
73 Information region C, overall height
80 Rear wall region
81 Cavity or filling (for example, gravel, sand)
82 Front wall
83 Installations, for example electric lines, water conduits, etc.
84 Concrete slab
85 Upper lining
86 Projecting region of 84
87 Train
88 Trapezium plate (with supplement of fine concrete)
89 Lining
90 Remaining cavities
91 Anchor plane for 82
92 Anchor plane for 80
93 Supplement of fine concrete
a Width, fixing parts
b Width, door opening
c Height, sliding doors
d Entire movable width
e Construction depth
g Floor spacing of 6
h Screw distance
i Screw spacing
k Depth of 6
l Distance of platform edge from 6
m,n,o Coordinates of 31
p Radius of tolerances
H For floor above upper edge
D Thickness of the door

1-30. (canceled)

31. A sliding door construction for platforms, by means of which, when closed, a passenger region of platforms can be separated from a track region if access to a train which has arrived is to be prevented, and which, when open, permits access to the train which has arrived, the sliding door construction comprising: stationary regions and sliding door, wherein the stationary regions and the sliding door have a height in the region of 1-2 m above a floor of a passenger region and no means for separating passenger region and track region are arranged above them, wherein the sliding doors are of self-supporting design and are guided movably in or on the stationary regions, in that there are an upper and a lower guide for this purpose, one guide being designed as a roller guide or as a ball bearing linear guide, and one guide being designed as a sliding guide or as a roller guide.

32. The sliding door construction as claimed in claim 31, wherein the lower guide is designed as a roller guide or as a ball bearing linear guide, and the upper guide is designed as a sliding guide.

33. The sliding door construction as claimed in claim 32, wherein the lower guide is essentially arranged in the lower region of the sliding door.

34. The sliding door construction as claimed in claim 32, wherein the upper guide is essentially arranged on the upper edge of the sliding door or is essentially arranged halfway up the sliding door.

35. The sliding door construction as claimed in claim 31, wherein the drive of the sliding doors is arranged on the guide which is designed as the roller guide or as the ball bearing linear guide and is preferably arranged at the bottom, and the driving force is transmitted with the aid of a toothed belt between a drive, which is arranged in the stationary region, and the sliding door.

36. The sliding door construction as claimed in claim 35, wherein the toothed belt is connected via a driver to the sliding door or, in particular, is preferably connected to a guide rail provided on the sliding door.

37. The sliding door construction as claimed in claim 35, wherein the toothed belt is connected fixedly at its ends to a guide rail provided on the sliding door.

38. The sliding door construction as claimed in claim 35, wherein a drive for each sliding door is fastened on a base plate of the respective stationary region, the drive preferably being an electric motor drive with a worm gear, and in that the drive drives a toothed-belt driving roller which is arranged offset downward or upward from the main direction of the toothed belt via toothed-belt deflecting rollers.

39. The sliding door construction as claimed in claim 31, wherein a horizontal guide element is provided on the stationary region, in particular via at least two supporting pillars fastened on a base plate, which guide element has a length of at most a width of the stationary regions, and in that a guide rail is arranged on each sliding door and engages in the guide element or engages around the latter, with rollers or balls being provided to enable it to be movably displaced in the lateral direction.

40. The sliding door construction as claimed in claim 39, wherein the guide elements and the associated guide rails of two adjacent sliding doors are offset in their height at least to an extent such that the guide rails of open sliding doors provided at adjacently arranged door openings come to lie one above the other without any contact.

41. The sliding door construction as claimed in claim 38, wherein the toothed belt is essentially arranged below guide rails or a guide element.

42. The sliding door construction as claimed in claim 31, wherein the two guides are arranged on that side of the sliding door and of the stationary regions which faces away from the platform.

43. The sliding door construction as claimed in claim 31, wherein the upper guide which is designed as a sliding guide is a telescopic guide which is in at least three parts and has a guide profile connected fixedly to the stationary region, a guide-profile rail connected fixedly to the respective sliding door and a telescopic profile which is movable with respect to the two other elements.

44. The sliding door construction as claimed in claim 31, wherein the upper guide is essentially arranged halfway up the sliding door, with that region of the sliding door which is arranged above the upper guide being formed from glass, in particular preferably with an essentially exposed upper edge.

45. The sliding door construction as claimed in claim 31, wherein the upper guide has a guide profile, in particular preferably in the form of an H profile, which is arranged on the rear side of the fixing part and is fastened to the fixing part and engages in a slot of a guide profile which is configured as part of the sliding doors and is in the form of a sliding rail.

46. The sliding door construction as claimed in claim 31, wherein the stationary regions are each fastened, with the aid of anchor bolts or pins, to the floor of the passenger region via at least one base plate which is provided with an insulation layer covering the entire surface.

47. The sliding door construction as claimed in claim 46, wherein the insulation layer is composed of a synthetic material, in particular preferably of thermoplastic polyamide, preferably PA11, with a thickness in the region of 0.25-1 mm.

48. The sliding door construction as claimed in claim 46, wherein the base plate has fastening holes which have a substantially larger diameter than the anchor bolts or pins, and in that an insulating filling material, in particular of plastic or resin, such as, for example, acrylic casting resin, is arranged for the transmission of shearing force and for a positive-locking connection between base plate and anchor bolts or pins.

49. The sliding door construction as claimed in claim 31, wherein at least one of the stationary regions has, in the region of its upper edge, in particular preferably at east partially integrated in a covering bounding the upper edge of the respective stationary region indirect illumination elements for the passenger region.

50. The sliding door construction as claimed in claim 49, wherein the indirect illumination elements for the passenger region are lamps which form an essentially upwardly directed or at most vertically oriented tone of light, which tone of light provides indirect light from a ceiling for the passenger region.

51. The sliding door construction as claimed in claim 49, wherein further elements for better indirect illumination of the passenger region are arranged on a ceiling, said further elements preferably being one or more reflectors, in particular preferably in the form of mirrors, which are fastened to the ceiling.

52. The sliding door construction as claimed in claim 49, wherein the indirect illumination elements for the passenger region are fastened in a region of an upper edge of the stationary region in such a manner that the tone of light generated by them can be adapted to correspond to local requirements, with, in particular, a setting of a direction of the tone of light in a direction perpendicular to a direction in which the platform runs preferably being possible by rotation of the means designed as a lamp about an axis essentially parallel to the direction in which the platform runs.

53. A sliding door construction for platforms, by means of which, when closed, a passenger region of platforms can be separated from a track region if access to a train which has arrived is to be prevented, and which, when open, permits access to the train which has arrived, the sliding door construction comprising: stationary regions and sliding doors, and, if appropriate, stationary wall elements between the sliding doors and the stationary regions thereof, wherein the stationary regions, the stationary wall elements which are present, if appropriate, and the sliding doors are at a height in the region of 1-2 m above the floor of the passenger region and no means for separating passenger region and track region are arranged above them, wherein display elements for conveying information to people in the passenger region are arranged in at least one of the stationary regions, and/or in one of the sliding doors and/or in one of the stationary wall elements.

54. The sliding door construction as claimed in claim 53, preferably with the further features as claimed in claim 31, wherein the display elements involve at least one display elements selected from the following list: screen, in particular flat screen, such as LCD screen, LED display, projector, illuminated script, illuminated sign, advertising placard, said display elements preferably being provided in time-varying form.

55. The sliding door construction as claimed in claim 53, wherein the display elements involves a flat screen.

56. The sliding door construction as claimed in claim 53, wherein the stationary region, the sliding door and/or the stationary wall element has at least one transparent surface, such as, in particular, preferably a glass surface, which faces the passenger region, and in that the display element is arranged with respect to the passenger region behind said transparent surface, with it being possible, in particular, for a screen, preferably a flat screen, such as, for example, an LCD screen to be preferably arranged at least at eye level in the region of 100-200 cm above the floor and/or for a preferably variable advertisement to be arranged over at least half of the height of the stationary region, the sliding door and/or the stationary wall element.

57. The sliding door construction as claimed in claim 53, wherein the stationary region, the sliding door and/or the stationary wall element has a frame, and in that the display element is arranged on or in said frame on the side facing the sliding door or at the top of it, preferably essentially over at least one-half of the height of the stationary region, the sliding door and/or the stationary wall element.

58. The sliding door construction as claimed in claim 53, wherein the display elements convey information selected from the following list to passengers: advertising, news, sports events, timetables, current information about the trains for the platform and of the entire network, (interactive) Internet information, photographs, warning messages, entertainment, said information also being provided in combined form sequentially and/or in parallel and, preferably, in time-varying form.

59. A method for installation of a sliding door construction as claimed in claim 31, wherein drill holes are provided in a floor, in that anchor bolts or pins are fastened, in particular screwed or cast, in said drill holes, in that insulating spacer disks are placed onto the anchor bolts or pins and subsequently a base plate with correspondingly provided bores is placed over the anchor bolts or pins protruding over the floor, in that the intermediate spaces between the bores and the anchor bolts or pins are filled with filling material and in that, after further insulating spacer disks are placed on, the base plate is fastened with the aid of nuts.

60. The method as claimed in claim 59, wherein the assembly of the stationary regions is screwed onto the base plate which is fastened to the floor, with it being ensured that there is no contact with the floor, and with the assembly preferably already being screwed firmly to the base plate.
